(19) United States
(12) Patent Application Publication
(10) Pub. No.: US 2007/0239877 A1
(43) Pub. Date: Oct. 11, 2007

(54) Function setting system, setting machine, function setting method, program, and computer-readable recording medium

(75) Inventor: Norio Uchida, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/729,861

(22) Filed: Mar. 30, 2007

(30) Foreign Application Priority Data
Mar. 31, 2006 (JP) 2006-097615

(51) Int. Cl. G06F 15/16

(52) U.S. Cl. 709/228

(57) ABSTRACT

To provide a function setting system, a function setting method, and the like that can easily and efficiently perform accurate setting and simultaneously perform setting for plural devices even when a large number of parameters have to be accurately set the same among devices that perform communication with one another. A setting object machine displays communication setting for provisional connection as an image pattern using an image-pattern display unit. A setting machine photographs the image pattern using an imaging device and analyzes the image pattern using an image-information analyzing unit to deduce setting of the setting machine necessary for communicating with the setting object machine. On the other hand, the setting machine generates setting information of a desired network using a regular-connection individual-setting generating unit. The setting machine transmits the setting information of the network generated to the setting object machine through a communication path established in a one-to-one relation.

### BACKGROUND OF THE INVENTION

1. Field of the Invention

The present invention relates to a function setting system, a setting machine, a function setting method, a program, and a computer-readable recording medium. More particularly, the present invention relates to a function setting system, a function setting method, and the like for easily and correctly setting, for example, in establishing a communication network, communication functions on the basis of image information displayed by terminal devices.

2. Description of Related Art

In recent years, with the advent of the communication standards such as IEEE (Institute of Electrical and Electronic Engineers) 802.11 and Bluetooth, there are increasing opportunities for general consumers to establish local (radio) communication networks. IEEE802.11 is defined on the basis of the network hierarchy model of IEEE802.3 that is the standard of Ethernet (registered trademark) set as a network standard. Thus, IEEE802.11 has high compatibility with Ethernet (registered trademark). On the other hand, Bluetooth is a radio communication technique for portable information devices. With Bluetooth, it is possible to exchange sound and data among notebook personal computers, PDAs (Personal Digital Assistants), cellular phones, and the like.

In using such communication standards, users often set parameters necessary for communication by themselves. The setting of the parameters is complicated. This is because, in order to perform communication according to the communication standards, in general, a large number of parameters have to be accurately the same among devices that communicate with one another. In particular, in radio communication, this is because it is necessary to set a larger number of parameters in order to secure confidentiality of communication. Convenience of communication would be improved if it is possible to change device settings according to situations and freely make connection with different communication partners. However, under the present situation, it is difficult to use the devices in this way because of the difficulty in the setting.

For example, document 1 (Japanese Patent Laid Open No. 2002-325079) discloses a setting system for a power line communication network with which address management and the like by an installer is unnecessary and it is possible to easily set a house code and an address in a device and easily perform address management and management of connection devices after the setting. In the system, a control terminal sets a house code and address data in a controlled terminal on the basis of house code announce data and address setting data.

For example, document 2 (Japanese Patent Laid Open No. 2004-178187) proposes a radio communication authentication apparatus that can safely and easily recognize a partner device in establishing and using a peer-to-peer simple network that does not require an access point. The apparatus analyzes barcode information displayed on an image display unit by the partner device to acquire an authentication password and performs communication with the partner device using this authentication password.

In the technique disclosed in document 1, only a house code and address data are set. However, it is unclear whether it is possible to accurately and easily set a larger number of parameters. Further, it is necessary to set a house code and address data for each of connection devices. This is not efficient.

The technique proposed in document 2 has the following problems. A first problem is that, since the technique requires that a radio ad-hoc network be established in advance, and it is not described how the ad-hoc network is built. A second problem is that, since communication between a partner device and one digital camera is assumed, it is impossible to constitute a network with three or more devices.

### SUMMARY OF THE INVENTION

Therefore, in view of the problems described above, it is an objective of the present invention to provide a function setting system, a function setting method, and the like that can easily and efficiently perform accurate settings and simultaneously perform settings for plural devices even when a large number of parameters have to be accurately the same among devices that perform communication with one another.

In order to attain such an objective, there is provided a function setting system including a setting object machine having a communication function for temporarily communicating with a setting machine that performs function setting and the setting machine having a communication function for temporarily communicating with the setting object machine. The setting object machine includes image-information displaying section that displays provisional connection information, which is information necessary for temporarily making connection with the setting machine, as image information, and provisional-connection setting section that sets, in the communication function of the setting object machine, the provisional connection information displayed as image information by the image-information displaying section. The setting machine includes image-information analyzing section that analyzes image information displayed by the image-information displaying section, a provisional connection section that sets the communication function of the setting machine based on the provisional connection information analyzed by the image-information analyzing section and temporarily making connection with the setting object machine, and a function-setting-information generating section that generates function setting information. Function setting for the setting object machine is performed when the setting object machine is connected by the provisional connection section and the function setting information generated by the function-setting-information generating section is transmitted to the setting object machine.

The function setting system including the setting machine and the setting object machine sets functions. The setting object machine includes the image-information displaying section and the provisional-connection setting section. The setting machine includes the image-information analyzing section, the provisional connection section, and the function-setting-information generating section.

In this system, first, the setting object machine displays provisional connection information, which is setting information necessary for the setting machine to perform temporary communication with the setting object machine, as image information. The setting machine photographs and analyzes the image information and acquires the provisional communication information to acquire a communication path to the setting object machine. On the other hand, the setting machine generates function setting information, which is information necessary for desired function setting. The setting machine transmits the function setting information generated to the setting object machine. The setting object machine updates the function setting information.

The function setting information may be non-provisional connection information, which is information necessary for establishing a group communication network among setting object machines. It is also possible that the non-provisional connection information is divided into common setting information common to the respective setting object machines and individual setting information different for each of the setting object machines, and the setting machine receives the common setting information, acquires the individual setting information from provisional connection with the setting object machines, and combines the common setting information and the individual setting information to generate final desired function setting information.

In this system, the setting object machine may display provisional connection information of provisional connection by a plurality of devices as one image information and the setting machine analyzes the image information, generates function setting information concerning a plurality of devices based on the provisional connection information, and transmits the function setting information to the setting object machine at a time.

Since the setting machine has the image-information analyzing section, the setting machine can easily and accurately perform setting even when setting of a large number of parameters is necessary. Since the setting machine can photograph and analyze image information of a plurality of setting object machines at a time, the setting machine can perform efficient setting of communication functions without performing setting for the setting object machines every time the setting machine communicates with the setting object machines. Moreover, the setting machine can easily, accurately, and efficiently perform setting of a communication function by one photographing and performing transmission once for setting for a plurality of devices.

There is also provided a setting machine used in a function setting system including a setting object machine having a communication function for temporarily communicating with a setting machine that performs function setting and the setting machine having a communication function for temporarily communicating with the setting object machine. The setting machine includes an image-information analyzing section that analyzes image information displayed by the image-information displaying section, a provisional connection section that sets the communication function of the setting machine based on provisional connection information analyzed by the image-information analyzing section and temporarily making connection with the setting object machine, and a function-setting-information generating section that generates function setting information desired by a user.

There is also provided a function setting method for a function setting system including a setting object machine having a communication function for temporarily communicating with a setting machine that performs function setting and the setting machine having a communication function for temporarily communicating with the setting object machine. The setting object machine includes an image-information displaying step of displaying provisional connection information, which is information necessary for temporarily making connection with the setting machine, as image information and a provisional-connection setting step of setting, in the communication function of the setting object machine, the provisional connection information displayed as image information in the image-information displaying step. The setting machine includes an image-information analyzing step of analyzing image information displayed in the image-information displaying step, a provisional connection step set in the communication function of the setting machine on the basis of the provisional connection information analyzed in the image-information analyzing step and temporarily making connection with the setting object machine, and a function-setting-information generating step of generating function setting information desired by a user. Function setting for the setting object machine is performed when the setting object machine is connected in the provisional connection step and the function setting information generated in the function-setting-information generating step is transmitted to the setting object machine.

There is also provided a computer program that causes the setting machine and the setting object machine to execute the function setting method.

The computer program may be stored in a computer-readable recording medium.

### BRIEF DESCRIPTION OF THE DRAWINGS

The objectives and features of the present invention will become more apparent from the consideration of the following detailed description taken in conjunction with the accompanying drawings, in which:

FIG. 1 is a functional block diagram showing structures of a setting machine and a setting object machine in a function setting system;

FIG. 2 is a diagram showing a communication state in the function setting system;

FIG. 3 is a flowchart showing a flow of a setting operation in the function setting system;

FIG. 4 is a diagram for explaining provisional connection setting information in the function setting system;

FIG. 5 is a diagram for explaining regular connection setting information in the function setting system;

FIG. 6 is a functional block diagram showing structures a setting machine and a setting object machine in a function setting system; and

FIG. 7 is a functional block diagram showing structures of a setting machine and a setting object machine in a function setting system.

### DESCRIPTION OF THE PREFERRED EMBODIMENTS

Embodiments of the present invention will be explained with reference to the accompanying drawings.

### First Embodiment

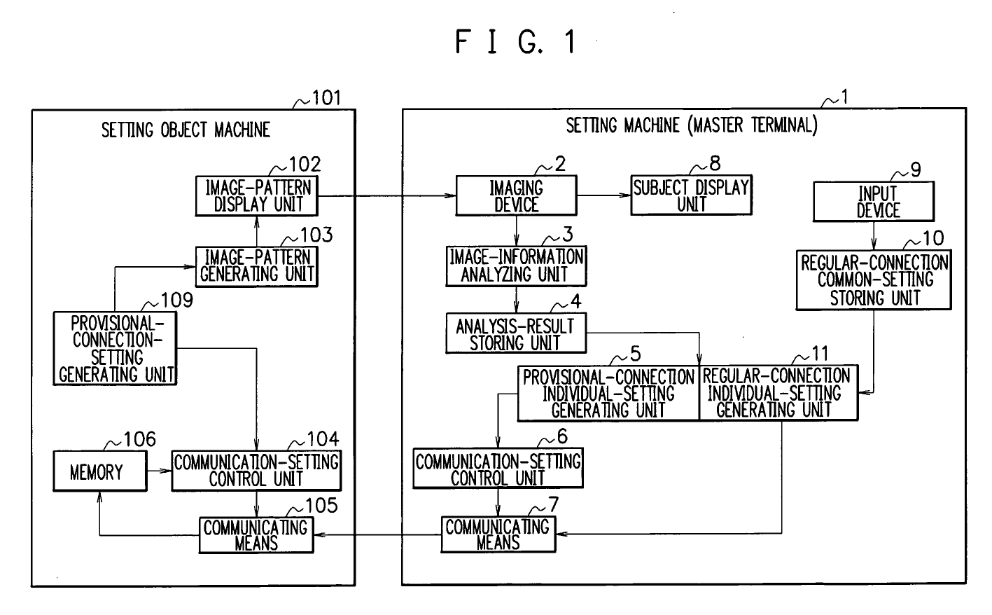

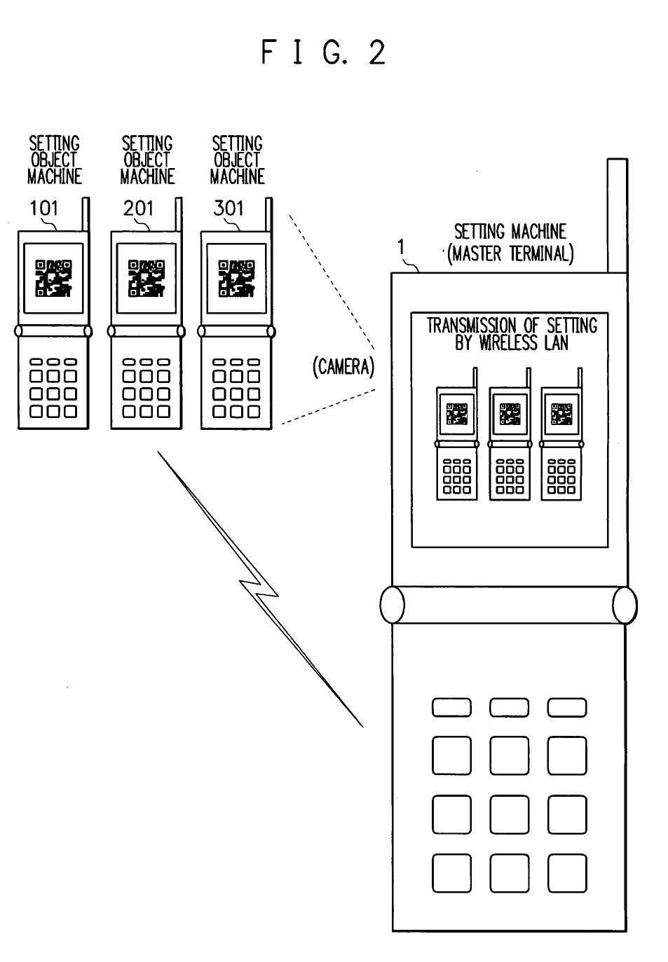

FIG. 1 is a functional block diagram showing structures of a setting machine and a setting object machine in a function setting system according to a first embodiment. FIG. 2 is a diagram showing a communication state in the function setting system. The function setting system includes a setting machine (a master terminal) 1 that controls automatic setting and a setting object machine 101 to be a target of setting. It is assumed that, as shown in FIG. 2, there is a plurality of setting object machines (setting object machines 101, 201, 301, etc.) that has the same structure as the setting object machine 101 in FIG. 1.

First, a structure of the setting machine in the function setting system will be explained. A setting machine 1 includes an imaging device 2, an image-information analyzing unit 3, an analysis-result storing unit 4, a provisional-connection individual-setting generating unit 5, a communication-setting control unit 6, communicating means 7, a subject display unit 8, an input device 9, a regular-connection common-setting storing unit 10, and a regular-connection individual-setting generating unit 11.

The device 2 converts an image into electronic information and records the electronic information. Examples of the device 2 include a CMOS (Complementary Metal Oxide Semiconductor) sensor and a CCD (Charge Coupled Devices) camera.

The unit 3 extracts an image pattern such as a barcode from image information photographed by the device 2 and analyzes the image pattern to decrypt information on setting object machines embedded in the image pattern. The unit 4 stores the information on the setting object machines decrypted by the unit 3.

The unit 5 judges, with reference to the information on the setting object machines stored in the unit 4, how communicating means for the setting machine should be set in order to establish provisional connection with the setting object machines and generates provisional connection setting information of the setting machine. Provisional connection means connection temporarily established between the setting machine 1 and the setting object machine 101.

The unit 6 controls the communicating means 7 on the basis of the provisional connection setting information generated by the unit 5. The communicating means 7 has a function for exchanging information with the setting object machine 101.

The unit 8 displays an image captured by the device 2 to allow a user of a device to check an object to be photographed. Examples of the unit 8 include an LCD (Liquid Crystal Display) and a CRT (Cathode Ray Tube). The unit 8 may be an optical finder.

The device 9 is means used by the user to input regular connection setting information. Regular connection means a network finally established among the setting object machines. The unit 10 holds the regular connection setting information (common setting information) inputted by the user using the device 9.

The unit 11 generates, on the basis of the common setting information held by the unit 10, regular connection setting information to be transmitted to the respective setting object machines. This is because it may be insufficient to apply common setting to all terminals, for example, it may be necessary to allocate different identifiers to the setting object machines, respectively. The identifiers in this context are like IP addresses in an IP network or telephone numbers in a telephone network.

A structure of the setting object machine in the function setting system according to this embodiment will be explained. The setting object machine 101 includes an image-pattern display unit 102, an image-pattern generating unit 103, a communication-setting control unit 104, communicating means 105, a memory 106, and a provisional-connection-setting generating unit 109.

The unit 102 displays an image pattern such as a barcode. Examples of the unit 102 include an LCD and a CRT. The unit 109 holds and generates communication setting for establishing provisional connection with the setting machine 1. The unit 103 converts information sent from the unit 109 into an image pattern such as a barcode. The unit 104 acquires and controls settings of the communicating means 105. The communicating means 105 has a function for exchanging information with the setting machine 1. The memory 106 holds regular connection setting information sent from the setting machine 1.

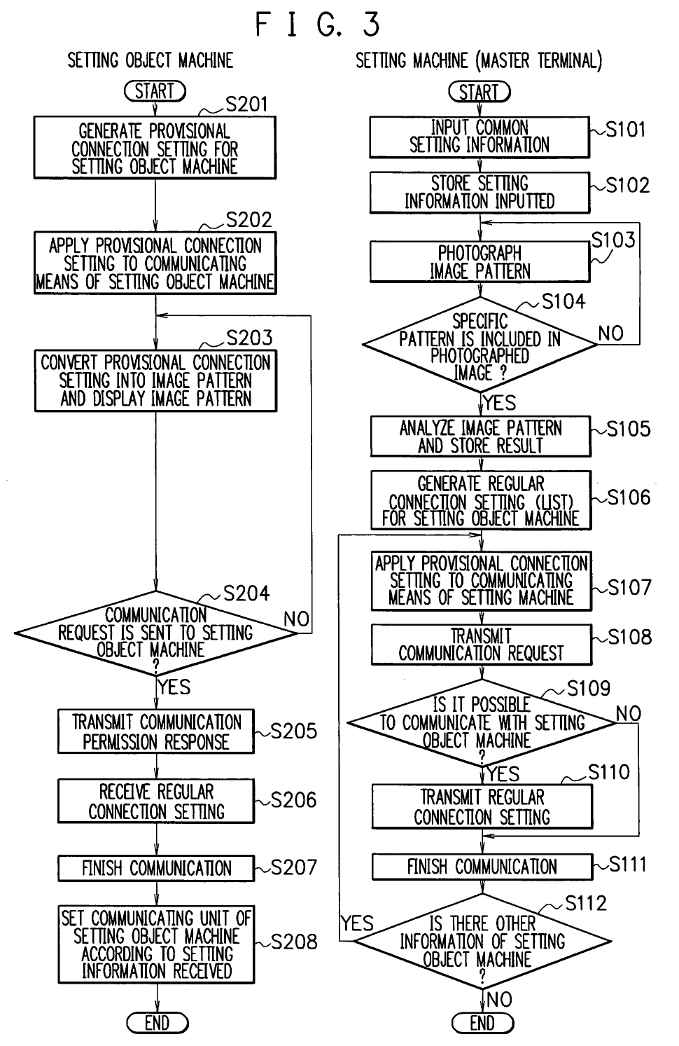

A setting operation in the function setting system will be explained. FIG. 3 is a flowchart showing a flow of the setting operation in the function setting system. A flow of operations of the setting object machine is shown on the left side and a flow of operations of the setting machine is shown on the right side.

First, the user inputs setting information for a network, which the user intends to constitute with the setting object machines 101 to 301, using the device 9 of the setting machine 1 (step S101). The setting information in this context is, for example, in the case of a wireless LAN, an ESSID (Extended Service Set Identifier), a communication mode, an authentication system, a WEP (Wired Equivalent Privacy) key, and the like. The setting information inputted from the device 9 is held in the unit 10 (step S102).

Since the setting machine 1 transmits the regular connection setting information to the setting object machine 101, it is necessary to make settings of the communicating means 7 be the same as settings of the communicating means 105 to bring both the communicating means into a state in which the communicating means are capable of communicating with each other. In other words, it is necessary to provisionally connect the communicating means 7 and the communicating means 105 as described above. A state in which settings are automatically performed using the means describe here is referred to as an automatic setting mode. Both the setting object machine 101 and the setting machine 1 enter the automatic setting mode according to operation by the user.

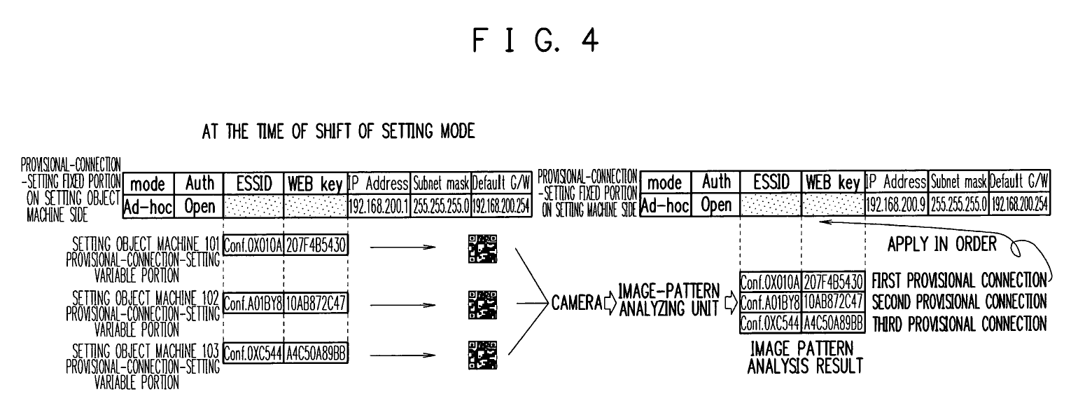

When the setting object machine 101 shifts to the automatic setting mode according to operation by the user (input from the device 9), in the setting object machine 101, first, the unit 109 generates provisional connection setting information, which is setting information for provisional connection (step S201). FIG. 4 is a diagram for explaining the provisional connection setting information in the function setting system. For example, when the communicating means 105 is a wireless LAN device, as shown in FIG. 4, the provisional connection setting information is an ESSID, a communication mode, an authentication system, a WEP key, and the like. An identifier of the communicating means 105 on a network such as an IP address is also the provisional connection setting information. Items other than the ESSID and the WEP key are fixedly held in the setting object machine 101 in advance. It is also decided that the setting object machine 101 and the setting machine 1 hold the same information. The ESSID and the WEP key are generated at random on the basis of a random number sequence every time provisional connection is performed.

The provisional connection setting information generated is applied to the communicating means 105 of the setting object machine 101 through the unit 104 (step S202). At the same time, information dynamically generated (i.e., the ESSID and the WEP key) in the provisional connection setting information is converted into an image pattern by the unit 103 and displayed on the unit 102 (step S203). The setting object machine 101, which has displayed the image pattern, comes into a communication request waiting state (step S204). The setting object machines 201 and 301 also shift to the automatic setting mode and display image patterns in the same manner.

On the other hand, as shown in FIG. 2, the user photographs the setting object machines 101 to 301 using the setting machine 1 (step S103). The image pattern displayed on the unit 102 is captured by the device 2 and displayed on the unit 8.

The subject image converted into the electronic information by the device 2 is sent to the unit 3. The unit 3 extracts image patterns such as a barcode and a two-dimensional code from the photographed image. When the image pattern displayed by the unit 102 is detected, the unit 3 decrypts the image pattern. The decrypted provisional connection setting information of the setting object machines is recorded in the unit 4 for each of the image patterns (for each of the setting object machines) (step S104/YES, step S105). As described later, the recorded provisional connection setting information of the setting object machines is used for generation of regular connection setting information and generation of provisional connection setting information applied to the communicating means 7 of the setting machine 1 (steps S106 and S107).

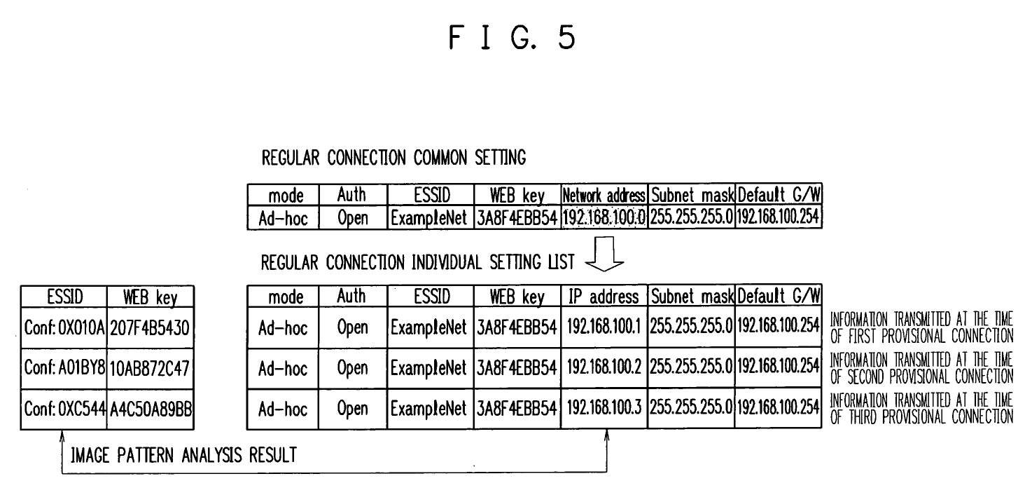

First, the setting machine 1 generates regular connection setting information of the setting object machines 101 to 301 using the unit 11 (step S106). FIG. 5 is a diagram for explaining regular connection setting information in the function setting system. When three sets of ESSIDs and WEP keys are obtained as a result of the image analysis in step S105, the unit 11 generates three terminal identifiers corresponding to the ESSIDs and WEP keys. IP addresses correspond to the terminal identifiers. Referring to the common setting information stored in the unit 10, a network address is 192.168.100.0 and a sub-net mask is 255.255.255.0. Thus, it is possible to set IP addresses allocated to the respective setting object machines as 192.168.100.1 to 3 (an IP address serving as a start point may be inputted instead of the network address). Although the regular connection setting information is formed as a list in FIG. 5, the regular connection setting information may be formed as a table.

Subsequently, the setting machine 1 applies the provisional connection setting to the communicating means 7 of the setting machine 1 (step S107). As shown in FIG. 4, the unit 5 holds provisional connection setting information, which is decided between the setting machine 1 and the setting object machine 101, in advance (provisional connection is established if only a common ESSID and WEP key are shared with a setting object terminal). The provisional connection setting information includes a provisional-connection-setting fixed portion (information other than the ESSID and the WEP key), which is a fixed portion, and a provisional-connection-setting variable portion (the ESSID and the WEP key), which is a variable portion. The unit 5 applies the analyzed ESSID and the WEP key, which form the provisional-connection-setting variable portion, to the provisional-connection-setting fixed portion to generate provisional connection setting information. The settings based on the provisional connection setting information generated in this way is applied to the communicating means 7 by the unit 6 to bring the setting machine 1 and the setting object machine 101 into a state in which the setting machine 1 and the setting object machine 101 are capable of communicating with each other (a provisional connection state).

At this stage, the setting machine 1 transmits a communication request to the setting object machine 101 (step S108). The setting object machine 101, which has received the communication request from the setting machine 1 (step S204/YES), returns a communication permission response to the setting machine 1 (step S205). When the setting machine 1 receives the communication permission response from the setting object machine 101 and judges that it is possible to communicate with the setting object machine 101 (step S109/YES), the setting machine 1 transmits regular connection setting information corresponding to the ESSID used for the provisional connection in the regular connection setting information generated in step S106 to the setting object machine 101 through the communicating means 7 (step silo).

When the regular connection setting information is received, the setting object machine 101 temporarily stores the regular connection setting information in the memory 106 (step S206). When it is confirmed that the reception of the setting information is completed, the unit 104 finishes the communication (step S207) and updates the setting of the communicating means 105 according to the setting information stored in the memory 106 (step S208). Consequently, the communicating means 105 of the setting object machine 101 is set to a value inputted by the user using the device 9.

On the other hand, when the setting machine 1 finishes the communication with the setting object machine 101 (step S111), the setting machine 1 checks whether there is other decrypted information of the setting machine with reference to the unit 4 (step S112). Since the image patterns displayed by the setting object machines 201 and 301 are shown in the photographed image other than the image pattern displayed by the setting object machine 101, results obtained by decrypting the image patterns are also held in the unit 4 (step S112/NO). Therefore, the setting machine 1 repeats steps S107 to S111 for the setting object machines 201 and 301. When there is no more information to be referred to in the unit 4 (step S112/YES), the operations of the setting machine 1 end.

According to the operations described above, the communicating means of the setting object machines 101 to 301 are properly set and a network is established to allow the setting object machines 101 to 301 to communicate with each other.

A first advantage according to this embodiment is that when the user performs setting for a plurality of terminals, the user does not need to manually perform settings for the setting object machines one after another but only has to perform simple operations for inputting settings in the setting machine once and photographing the setting object machines once. This is because, when the setting object machines display image patterns and the setting machine analyzes the image patterns, it is possible to establish a communication path for transmitting common setting information.

A second advantage according to this embodiment is that even if the number of setting object machines increases, time and labor for performing settings for the setting object machines do not increase. This is because the setting machine can acquire image patterns, which are displayed by a plurality of setting object machines, by photographing the setting object machines once.

### Second Embodiment

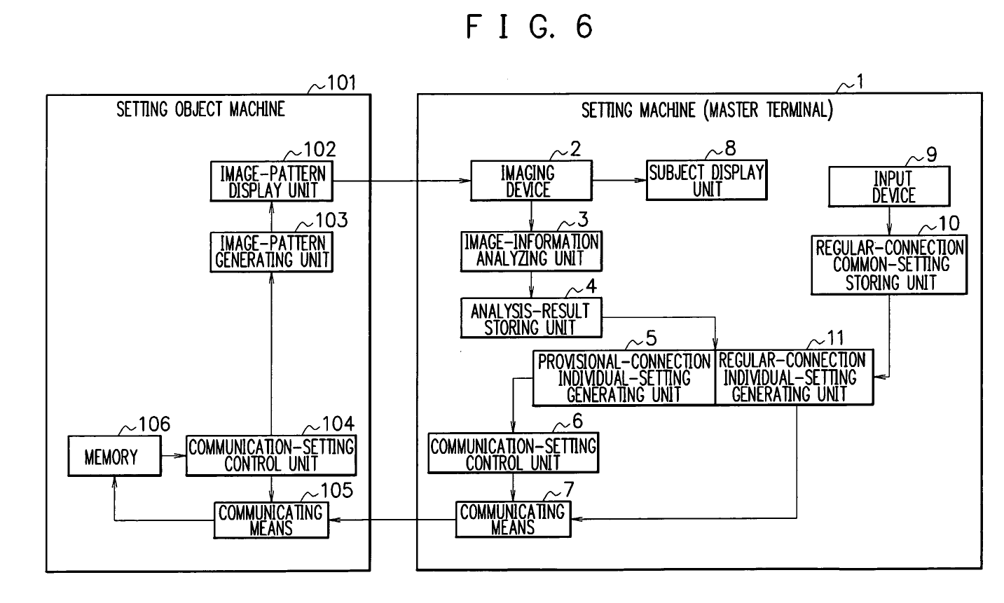

FIG. 6 is a functional block diagram showing structures of a setting machine and a setting object machine in a function setting system according to a second embodiment. The function setting system is different from that according to the first embodiment in that the setting object machine 101 does not include the unit 109.

In the first embodiment, a part of provisional connection setting information is decided in advance between the setting object machine 101 and the setting machine 1 and the provisional connection setting information decided is held in the respective machines. However, in the second embodiment, instead of using settings for provisional connection determined in advance, a present state of the communicating means 105 is acquired and used as setting for provisional connection.

In this case, when the setting object machine 101 shifts to the automatic setting mode, the unit 104 acquires present settings of the communicating means 105 and sends the setting to the unit 103. The unit 103 converts the received setting information into an image pattern.

However, in this embodiment, as described above, the setting machine 1 holds no provisional connection setting information in advance. Thus, the setting object machine 101 converts not only an ESSID and a WEP key but also information such as a communication mode, an authentication system, and an IP address into an image pattern and displays the image pattern on the unit 102.

On the other hand, the setting machine 1, which has photographed the image pattern, analyzes not only the ESSID and the WEP key but also the communication mode, the authentication system, and the IP address to deduce provisional connection setting information. A flow of operations after that is the same as the flow according to the first embodiment.

In this embodiment, since information included in the image pattern increases, a longer time is required for performing analysis processing for the information. However, since the setting object machine 101 does not include the unit 109, the structure of the setting object machine 101 is simplified.

### Third Embodiment

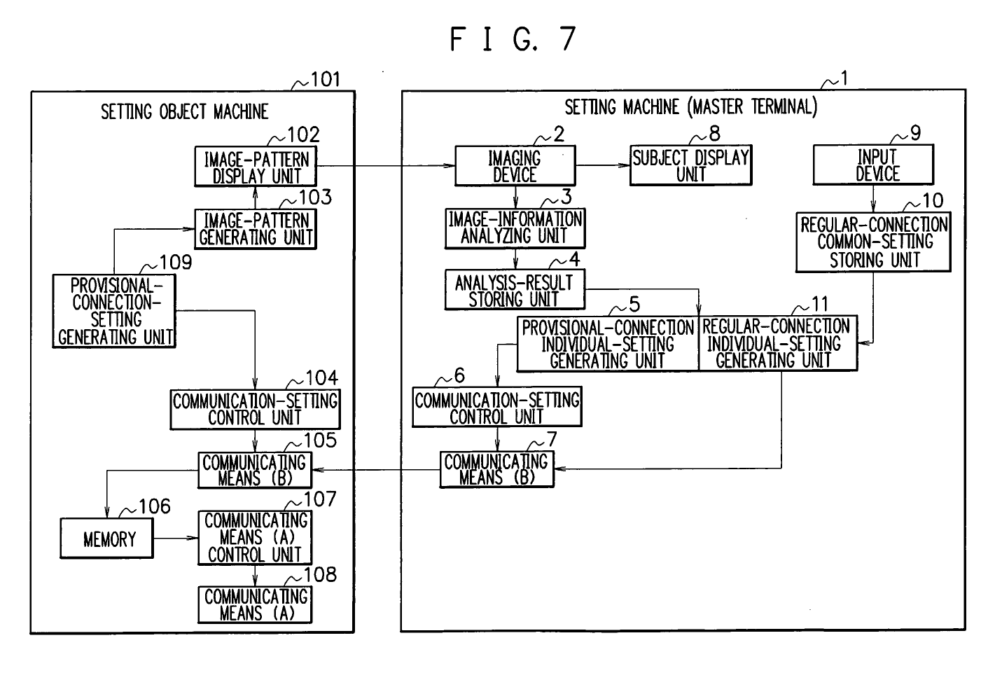

FIG. 7 is a functional block diagram showing structures of a setting machine and a setting object machine in a function setting system according to a third embodiment. The function setting system is different from that according to the first embodiment in that the setting object machine 101 includes two kinds of communicating means and a control unit for the communicating means.

In the first embodiment, all communicating means are identical. However, the communicating means do not have to be identical. If the setting object machine includes communicating means B serving as second communicating means other than communicating means A serving as first communicating means, it is also possible to use the communicating means B as a path for receiving setting information.

For example, when the communicating means A is a wireless LAN, the communicating means B may be infrared ray communication, visible light communication, near field communication such as UWB (Ultra Wide Band) and Bluetooth, or the like. When the setting object machine 101 is a telephone, a public line network can be the communicating means B. When the public line network is used as the communicating means B, the setting machine 1 and the setting object machine 101 may communicate through a packet switching network such as an IP or the setting machine 1 may make a telephone call to the setting object machine 101. In this case, setting information to be sent is converted into sound information such as a push tone or G3FAX and transmitted and received.

### Fourth Embodiment

In the first embodiment, when there is no other information of setting object machines in step S112 in FIG. 3, the operations of the setting machine 1 are finished. However, the regular connection setting information to be transmitted in step S112 may also be applied to the setting machine 1 itself. This makes it possible to add the setting machine 1 itself to the network formed by the setting object machines 101 to 301.

### Fifth Embodiment

In the first to the fourth embodiments, when the setting object machine 101 shifts to the automatic setting mode, settings of the communicating means 105 is changed, converted into an image pattern, and displayed. However, an object machine for which provisional setting is performed, and settings is converted into an image pattern and displayed is not limited to the communicating means 105. In other words, provisional setting for a plurality of devices may be performed and displayed as one image pattern. As regular connection setting information transmitted from the setting machine, information on the a plurality of devices may be transmitted at a time. For example, it is conceivable to collectively perform setting for a wireless LAN and Bluetooth.

### Sixth Embodiment

In the first to the fifth embodiments, the setting object machine and the setting machine have different functions, respectively. However, the setting object machine and the setting machine may have the functions of the other. For example, it is possible to use a terminal device such as a cellular phone with camera as the setting machine or the setting object machine if necessary.

### Seventh Embodiment

In the first to the sixth embodiments, the information sent from the setting machine to the setting object machine is inputted from the input device operated by the user. However, the information may be acquired from an external server or the like or may be acquired from removable media such as a CD-ROM and a memory card.

When computer-readable media, i.e., storage media having recorded therein a program code of software for realizing the functions of the embodiments described above are supplied to a setting machine and a setting object machine, computers (CPUs) of the setting machine and the setting object machine read out and execute the program code stored in the storage media. In this way, the objective of the present invention is also attained.

In this case, the program code itself read out from the storage media realizes the functions of the embodiments. The storage media having the program code stored therein constitute the present invention.

As the storage media for supplying the program code, it is possible to use, for example, a floppy (registered trademark) disk, a hard disk, an optical disk, a magneto-optical disk, a CD-ROM, a CD-R, a nonvolatile memory card, a ROM, and a magnetic tape.

The embodiments described above are preferred embodiments of the present invention and do not limit the scope of the present invention only to the embodiments. It is possible to carry out the present invention in various modifications without departing from the spirit of the present invention.

It is possible to apply the present invention to and utilize the present invention for, for example, a portable communication terminal, a cellular phone, and the like that are capable of communicating wirelessly. In terms of automatically performing setting for a network, it is possible to apply the present invention not only to a wireless network but also to a general wire network. Moreover, although the setting information of the communicating means is sent to the setting object machine in the embodiments described above, information to be sent is not limited to this. It is possible to generally utilize the communicating means as means for easily transmitting information to a large number of terminals.

As set forth above, it is possible to realize a function setting system, a function setting method, and the like that can easily and efficiently perform accurate setting and simultaneously perform setting for a plurality of devices even when a large number of parameters have to be accurately the same among devices that perform communication with one another.

What is claimed is:

1. A function setting system comprising:
a setting object machine that has a communication function for temporarily communicating with a setting machine; and
the setting machine that has a communication function for temporarily communicating with the setting object machine, wherein
the setting object machine includes:
an image-information displaying section that displays, as image information, provisional connection information, which is information necessary for temporarily making connection with the setting machine; and
a provisional-connection setting section that sets, in the communication function of the setting object machine, the provisional connection information displayed as image information by the image-information displaying section,
the setting machine includes:
an image-information analyzing section that analyzes image information displayed by the image-information displaying section;
a provisional connection section that sets the communication function of the setting machine based on the provisional connection information analyzed by the image-information analyzing section and temporarily establishes connection with the setting object machine; and
a function-setting-information generating section that generates function setting information, wherein
functions of the setting object machine is set when the setting object machine is connected by the provisional connection section and the function setting information generated by the function-setting-information generating section is transmitted to the setting object machine.

2. The function setting system according to claim 1, wherein the communication function is performed by at least one of radio communication of an infrastructure mode, radio communication of an ad-hoc mode, and wire communication.

3. The function setting system according to claim 1, wherein the function-setting-information generating section generates, from results of analysis of all pieces of image information displayed by one or more setting object machines, regular connection information, which is information necessary for establishing a group communication network among the setting object machines.

4. The function setting system according to claim 3, wherein
the function-setting-information generating section includes a common-setting-information acquiring section that acquires common setting information, which is setting information common to the setting object machines in the regular connection information, from an inputting section or from an external device, and
the establishment of the group communication network among the setting object machines is performed when the common setting information acquired by the common-setting-information acquiring section is transmitted to the setting object machines.

5. The function setting system according to claim 4, wherein
the function-setting-information generating section includes:
an individual-setting-information generating section that generates, in associating with the respective setting object machines, individual setting information, which is setting information different for each of the setting object machines in the regular connection information; and
a setting-information combining section that combines the common setting information acquired by the common-setting-information acquiring section and the individual setting information generated by the individual-setting-information generating section, and
the establishment of the group communication network among the setting object machines is performed when combined setting information combined by the setting-information combining section is transmitted to the setting object machines.

6. The function setting system according to claim 1, wherein
the function-setting-information generating section generates the function setting information concerning a plurality of functions, and
the function setting for the setting object machine is performed when the setting object machine is connected by the provisional connection section and the function setting information concerning a plurality of functions generated by the function-setting-information generating section is collectively transmitted to the setting object machine.

7. A setting machine for a function setting system including a setting object machine having a communication function for temporarily communicating with a setting machine that performs function setting and the setting machine having a communication function for temporarily communicating with the setting object machine, the setting machine comprising:
an image-information analyzing section that analyzes image information displayed by the image-information displaying section;
a provisional connection section that sets the communication function of the setting machine based on provisional connection information analyzed by the image-information analyzing section and temporarily establishes connection with the setting object machine; and
a function-setting-information generating section that generates function setting information.

8. The setting machine according to claim 7, wherein the function-setting-information generating section generates, from results of analysis of all pieces of image information displayed by one or more setting object machines, regular connection information, which is information necessary for establishing a group communication network among the setting object machines.

9. The setting machine according to claim 8, wherein the function-setting-information generating section includes common-setting-information acquiring section that acquires common setting information, which is setting information common to the setting object machines in the regular connection information, from an inputting section or from an external device.

10. The setting machine according to claim 9, wherein the function-setting-information generating section includes:
an individual-setting-information generating section that generates, in associating with the respective setting object machines, individual setting information, which is setting information different for each of the setting object machines in the regular connection information; and
a setting-information combining section that combines the common setting information acquired by the common-setting-information acquiring section and the individual setting information generated by the individual-setting-information generating section.

11. A function setting method in a function setting system including a setting object machine having a communication function for temporarily communicating with a setting machine that performs function setting and the setting machine having a communication function for temporarily communicating with the setting object machine, wherein
the setting object machine includes:
an image-information displaying step of displaying provisional connection information, which is information necessary for temporarily making connection with the setting machine, as image information; and
a provisional-connection setting step of setting, in the communication function of the setting object machine, the provisional connection information displayed as image information in the image-information displaying step,
the setting machine includes:
an image-information analyzing step of analyzing image information displayed in the image-information displaying step;
a provisional connection step set in the communication function of the setting machine based on the provisional connection information analyzed in the image-information analyzing step and temporarily making connection with the setting object machine; and
a function-setting-information generating step of generating function setting information, wherein
function setting for the setting object machine is performed when the setting object machine is connected in the provisional connection step and the function setting information generated in the function-setting-information generating step is transmitted to the setting object machine.

12. The function setting method according to claim 11, wherein, in the function-setting-information generating step, from results of analysis of all pieces of image information displayed by one or more setting object machines, regular connection information, which is information necessary for establishing a group communication network among the setting object machines, is generated.

13. The function setting method according to claim 12, wherein
the function-setting-information generating step includes a common-setting-information acquiring step of acquiring common setting information, which is setting information common to the setting object machines in the regular connection information, from an inputting section or from an external device, and
the establishment of the group communication network among the setting object machines is performed when the common setting information acquired in the common-setting-information acquiring step is transmitted to the setting object machines.

14. The function setting method according to claim 13, wherein
the function-setting-information generating step includes:
an individual-setting-information generating step of generating, in associating with the respective setting object machines, individual setting information, which is setting information different for each of the setting object machines in the regular connection information; and
a setting-information combining step of combining the common setting information acquired in the common-setting-information acquiring step and the individual setting information generated in the individual-setting-information generating step, and
the establishment of the group communication network among the setting object machines is performed when combined setting information combined in the setting-information combining step is transmitted to the setting object machines.

15. The function setting method according to claim 11, wherein
in the function-setting-information generating step, the function setting information concerning a plurality of functions is generated, and
the function setting for the setting object machine is performed when the setting object machine is connected in the provisional connection step and the function setting information concerning a plurality of functions generated in the function-setting-information generating step is collectively transmitted to the setting object machine.

16. A computer program that causes the setting machine and the setting object machine to execute the function setting method according to any one of claims 11 to 15.

17. A computer-readable recording medium storing the program according to claim 16.
